(19) United States
(12) Patent Application Publication
(10) Pub. No.: US 2025/0222994 A1
(43) Pub. Date: Jul. 10, 2025

(54) AIR SKIRT APPARATUS FOR VEHICLE

(71) Applicant: HYUNDAI MOBIS CO., LTD., Seoul (KR)

(72) Inventors: Jae Sup BYUN, Yongin-si (KR); Jang Ho KIM, Yongin-si (KR)

(73) Assignee: HYUNDAI MOBIS CO., LTD., Seoul (KR)

(21) Appl. No.: 18/808,525

(22) Filed: Aug. 19, 2024

(30) Foreign Application Priority Data
Jan. 9, 2024 (KR) 10-2024-0003568

(51) Int. Cl. B62D 35/00

(52) U.S. Cl. CPC B62D 35/005

(57) ABSTRACT

An air skirt apparatus for a vehicle and system therefor are provided. The apparatus includes: a first housing comprising an extraction hole; a skirt unit including a first skirt movably disposed inside the first housing and configured to protrude outside the first housing through the extraction hole, and a second skirt configured to tilt by rotating after a complete extraction of the first skirt; a support unit configured to move in the same direction as the first skirt and rotatably support the second skirt tilting after the complete extraction of the first skirt; and a lighting module coupled to the first housing and configured to illuminate the first skirt and the second skirt in response to the first skirt being moved outward from the first housing.

### CROSS-REFERENCE TO RELATED APPLICATION(S)

The present application claims priority to and the benefit under 35 USC § 119 of Korean Patent Application No. 10-2024-0003568, filed Jan. 9, 2024, in the Korean Intellectual Property Office, the entire disclosure of which is incorporated herein by reference for all purposes.

### BACKGROUND

### 1. Field

The present invention relates to an air skirt apparatus for vehicles

### 2. Description of the Related Art

Vehicles experience air resistance due to collisions with air during driving, which reduces fuel economy. Therefore, vehicles need structural features that reduce air resistance during driving, improve aerodynamic performance, and enhance fuel efficiency.

One example of a device for improving aerodynamic performance is the air skirt device, which is placed at the front of the vehicle to reduce the amount of air entering the underbody through the front bumper during high-speed driving, thereby promoting enhanced aerodynamic performance. The air skirt device may include an outwardly projecting first skirt, a second skirt positioned below the first skirt and pivotally connected to the first skirt to tilt rearward, a rotational axis connected to the second skirt to rotate it, and a control device connected to the rotational axis to power its rotation.

However, traditional air skirt devices have faced issues where the tilting second skirt, due to inadequate fixing structures, creates a gap between the second skirt and the control device after rotation, leading to the second skirt wobbling due to the external wind. Consequently, this leads to the deterioration of the wind blocking performance of the second skirt. Furthermore, the wobbling of the second skirt introduces fatigue and wear, leading to its damage and reduced durability.

To address this issue, an air skirt device with a support structure for the second skirt to prevent it from wobbling due to wind forces was developed, but this air skirt device has a structure that extends from the inside of the bumper towards the road surface. Consequently, the invisibility of deployed first and second skirts, despite being deployed, undermines efforts to enhance the vehicle's front-end design aesthetics.

Therefore, to improve the front-end design aesthetics of the vehicle, there is a need for a structure that increases the frequency of visual attention towards the deployed first and second skirts.

### SUMMARY

The present invention has been conceived to solve the above problems and it is an object of the present invention to provide an improved air skirt apparatus for vehicles that is capable of increasing the frequency of visual attention towards the deployed first and second skirts.

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In a general aspect of the disclosure, an air skirt apparatus for a vehicle, includes: a first housing including an extraction hole; a skirt unit including: a first skirt movably disposed inside the first housing and configured to protrude outside the first housing through the extraction hole; and a second skirt configured to tilt by rotating after a complete extraction of the first skirt; a support unit configured to move in the same direction as the first skirt and rotatably support the second skirt tilting after the complete extraction of the first skirt; and a lighting module coupled to the first housing and configured to illuminate the first skirt and the second skirt in response to the first skirt being moved outward from the first housing.

The lighting module may include: a second housing coupled to the first housing; a lens disposed in the second housing and configured to face the second skirt before tilting; and a light source unit disposed between the second housing and the lens and configured to illuminate light toward the lens.

The first skirt may include: a first skirt body disposed movably inside the first housing; and a first pattern part formed on an exposed surface of the first skirt body and comprising first convex portions and first concave portions arranged alternately.

The second skirt may include: a second skirt body arranged to be tiltable in relation to the first skirt body of the first skirt; and a second pattern part formed on an exposed surface of the second skirt body and comprising second convex portions and second concave portions arranged alternately, the second pattern part being arranged on a same line as the first pattern part of the first skirt.

The second pattern part of the second skirt may be exposed externally after the tilting of the second skirt body.

The apparatus may further include: a slide cover fixedly installed on the first skirt, wherein the support unit is slidably arranged on the slide cover.

The apparatus may further include a link unit connected to the support unit to move the support unit, wherein the support unit may include: a first support block connected to the link unit; and a second support block coupled with the first support block and movably disposed on the slide cover.

The second support block of the support unit may include: a first movable part positioned inside of the slide cover; a second movable part positioned at one end of the second movable part outside of the slide cover; and a support protrusion positioned on the second movable part and configured to movably support the second skirt.

The apparatus may further include a stopper rotatably coupled to the slide cover and contacting the first movable part of the second support block of the support unit.

The stopper may be pressed by the second support block of the support unit, and the second support block may move in linkage with the movement of the link unit, to activate the movement path of the first movable part.

In another general aspect of the disclosure, an air skirt system for a vehicle, includes: a housing; a first air skirt; a second air skirt attached to the first air skirt; an actuator; a controller configured to control the actuator to move the first air skirt to at least one of: a retracted position in which the first air skirt is retracted in the housing; an extended position in which the first air skirt is extended out of the housing; a tilted position in which the second air skirt is rotated in relation to the first air skirt; or any combination thereof; and one or more light modules coupled to at least one of the housing, the first skirt, the second skirt, or any combination thereof, wherein the controller is further configured to control the one or more light modules to illuminate at least one of the housing, the first skirt, the second skirt, or a combination thereof, in at least one of the retracted position, the extended position, or the tilted position.

The housing may include an extraction hole through which the first skirt protrudes out of or retracts into the housing.

The controller may be further configured to control the second skirt to tilt after the first skirt is moved into the extended position.

The air skirt system may further include: a support attached to the first skirt and configured to support the second skirt, and enable the second skirt to rotate in the tilted position.

The one or more lighting modules may include: a lens configured to face at least one of the housing, the first skirt, the second skirt, or any combination thereof; and a light source configured to illuminate light toward the lens.

The first skirt may include: a first skirt body disposed movably inside the housing; and a first pattern part formed on an exposed surface of the first skirt body, the first pattern part including first convex portions and first concave portions arranged alternately.

The second skirt may include: a second skirt body configured to be tiltable in relation to the first skirt body of the first skirt; and a second pattern part formed on an exposed surface of the second skirt body and including second convex portions and second concave portions arranged alternately, and the second pattern part may be arranged on a same line as the first pattern part of the first skirt.

The second pattern part of the second skirt may be configured to be exposed externally after the second skirt body is tilted.

The apparatus may further include a slide cover fixedly installed on the first skirt, wherein the support may be slidably arranged on the slide cover.

### BRIEF DESCRIPTION OF THE DRAWINGS

FIG. 1 is a perspective view of the vehicle air skirt apparatus according to an embodiment of the present invention;

FIG. 2 is an exploded perspective view of the vehicle air skirt apparatus according to an embodiment of the present invention;

FIG. 3 is a diagram illustrating the extraction hole formed in the first housing;

FIG. 4 is a diagram illustrating the second skirt;

FIG. 5 shows a diagram illustrating the operational control unit coupled to the first skirt and second skirt;

FIG. 6A is a diagram illustrating the slide cover coupled to the first skirt;

FIG. 6B is a diagram illustrating the first support block arranged on the slide cover;

FIG. 7 is an exploded perspective view of the support unit;

FIG. 8 is a diagram illustrating cross-section of the first skirt, slide cover, support unit, and auxiliary plate;

FIG. 9 is a diagram illustrating cross-section of the support protrusions of the second support block in the state of being inserted into the first slot hole of the second skirt;

FIG. 10 is a diagram illustrating cross-section of the stopper coupled to the slide cover and second auxiliary plate;

FIG. 11 is a diagram illustrating the second support block and stopper in the first state;

FIG. 12 is a diagram illustrating the second support block and stopper in the second state;

FIG. 13 is a diagram illustrating the second support block and stopper in the third state;

FIG. 14 is a diagram illustrating the arrangement of the side plate and rail block;

FIG. 15 is a diagram illustrating the connecting bracket connecting the second skirt and side plate;

FIG. 16 is a diagram illustrating the air skirt apparatus for a vehicle in the first state, second state, and third state according to an embodiment of the present invention;

FIG. 17 is an exploded perspective view of the lighting module;

FIG. 18 is a diagram illustrating cross-section of the lighting module;

FIG. 19 is a diagram illustrating the light source of the lighting module illuminating the first skirt and second skirt in the second state and third state according to an embodiment of the present invention; and

FIG. 20 is a diagram illustrating the first skirt and second skirt separated apart from each other.

### DETAILED DESCRIPTION

While the present invention admits various modifications, the following detailed descriptions and drawings focus on preferred embodiments for clarity. However, the embodiments are not intended to limit the invention and it should be understood that the embodiments encompass all modifications, equivalents, and alternatives within the spirit and scope of the invention.

As used herein, terms including an ordinal number such as “first” and “second” can be used to describe various components without limiting the components. The terms are used only for distinguishing one component from another component. For example, a first element may be referred to as a second element and, similarly, the second element may be referred to as the first element, without departing from the scope of the present invention. The expression “and/or” is used to convey the possibility of including either a combination of multiple related listed items or any one of the related listed items.

It will be understood that when a component is referred to as being “connected to” or “coupled to” another component, it can be directly connected or coupled to the other component or intervening component may be present. In contrast, when a component is referred to as being “directly connected to” or “directly coupled to” another component, there are no intervening component present.

In the description of embodiments, when a component is described as being formed or placed “on or under” another component, “on (above)” or “under (below)” may include not only cases where two components directly contact each other but also cases where one or more other components are formed or positioned between the two components. Additionally, when expressed as “on (above or under (below),” it may include not only the upward direction but also the downward direction relative to a single component.

The terminology used in this application is employed merely to describe specific embodiments and is not intended to limit the scope of the present invention. The singular forms are intended to include the plural forms as well unless the context clearly indicates otherwise. In this application, terms such as “comprising” or “having” indicate the presence of the features, numbers, steps, operations, components, or parts listed in the specification, without excluding the presence or possibility of one or more other features, numbers, steps, operations, components, or parts or their combinations.

Unless otherwise defined herein, all terms including technical or scientific terms used herein have the same meanings as commonly understood by those skilled in the art to which the present invention belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Hereinafter, a description is made of the air skirt apparatus for a vehicle with reference to the accompanying drawings where identical or corresponding components are assigned the same reference numbers, and redundant descriptions are omitted.

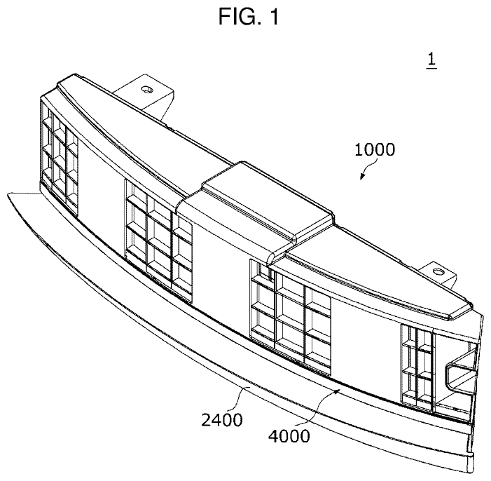

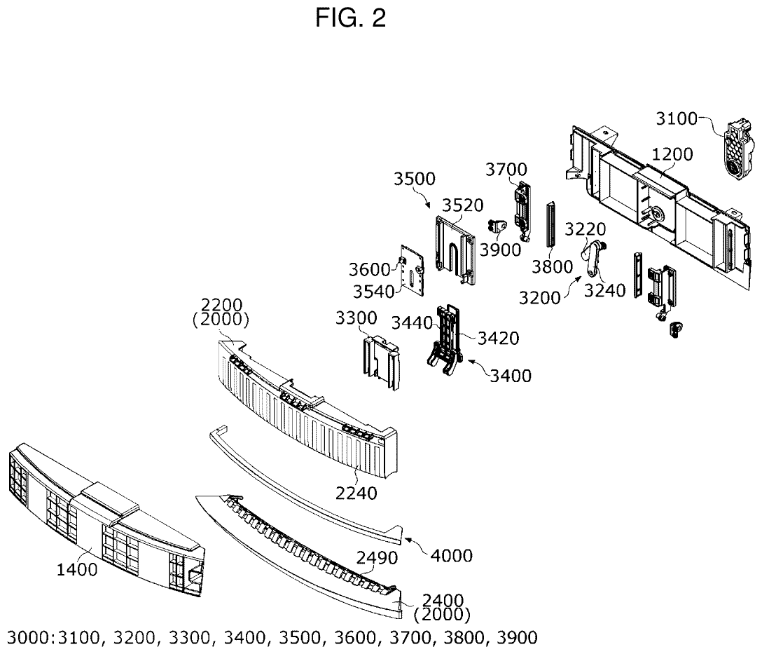

FIG. 1 is a perspective view of the vehicle air skirt apparatus according to an embodiment of the present invention, and FIG. 2 is an exploded perspective view of the vehicle air skirt apparatus according to an embodiment of the present invention.

With reference to FIGS. 1 and 2, the vehicle air skirt apparatus 1 according to an embodiment of the present invention may be arranged in the front portion of the vehicle in the length direction. The vehicle air skirt apparatus 1 may allow or block the flow of the external wind into the interior of the vehicle based on the selection of the occupants. The vehicle air skirt apparatus 1 may include a first housing 1000, a skirt unit 2000, an operation control unit 3000, and a lighting module.

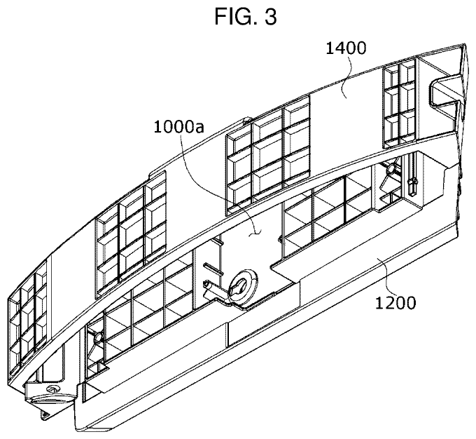

FIG. 3 is a diagram illustrating the extraction hole formed in the first housing.

With reference to FIGS. 1 to 3, the first housing 1000 may accommodate a portion of the skirt unit 2000 inside to guide the movement of the skirt unit 2000 and may be coupled with the operation control unit 3000 to support the operation control unit 3000. The first housing 1000 may include a first-1 housing 1200 and a first-2 housing 1400.

The first-1 housing 1200 may support a portion of the components of the operation control unit 3000 other than the actuator 3100 to be described later. The first-1 housing 1200 may support the actuator 3100 to be described later. The actuator 3100 may be positioned on the outer side of the first-1 housing 1200.

The first-2 housing 1400 may be positioned in front of the first-1 housing 1200 along the length direction. Here, the length direction may refer to the same direction as that from the passenger compartment (not shown) towards the engine compartment (not shown) of the vehicle. The first-2 housing 1400 may be coupled to and supported by the first-1 housing 1200. The first-2 housing 1400 may cover the front area of the first-1 housing 1200 along the length direction.

As shown in FIG. 3, the first housing 1000 may form an extraction hole 1000a. In more detail, an extraction hole 1000a may be formed by the first-1 housing 1200 closing against the open side of the first-2 housing 1400. The extraction hole 1000a formed by the first housing 1000 may serve as a movable area for a portion of the skirt unit 2000 and a portion of the operation control unit 3000 that are located inside the first housing 1000.

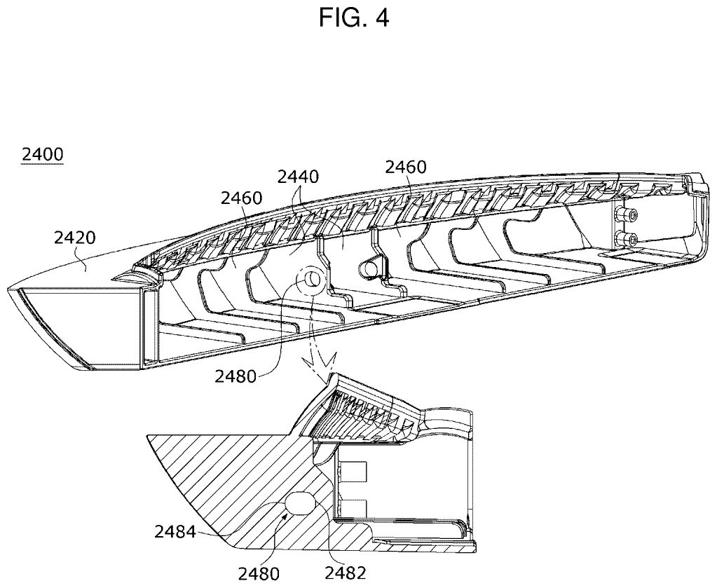

FIG. 4 is a diagram illustrating the second skirt.

With reference to FIGS. 1, 2, and 4, the skirt unit 2000 may be positioned movably inside the first housing 1000 and may include a first skirt 2200 capable of protruding outside the first housing 1000 through the extraction hole 1000a and a second skirt 2400 capable of pivotally tilting after the complete extraction of the first skirt 2200.

As shown in FIG. 1, the first skirt 2200 may be moved towards the outside of the first housing 1000 by the operation control unit 3000 while being positioned inside the first housing 1000. In this configuration, the first skirt 2200 may be moved in the height. Here, the height direction may be the direction perpendicular to the length direction. The first skirt 2200 may include a first skirt body 2220 and a first pattern part 2240.

The first skirt body 2220 may be a hollow, thin-walled frame. The first skirt body 2220 may be moved along the height direction to protrude outwards from the housing 1000 through the extraction hole 1000a. As a result, the first skirt 2200 may block the airflow.

The first pattern part 2240 may be formed on the exposed surface of the first skirt body 2220. As shown in FIG. 2, the first pattern part 2240 may be formed along the height direction on the exposed surface of the first skirt body 2220. The first pattern part 2240 includes first convex portions and first concave portions that are alternately arranged. In more detail, the exposed surface of the first skirt body 2220 may be patterned with alternating concave and convex regions, where the concave regions form multiple first concave portions, each separated by a first convex portion.

The second skirt 2400 may be attached to the first skirt 2200. In more detail, the second skirt 2400 maintains contact with the first skirt 2200 without being fixed to the first skirt 2200, and may be pivoted to tilt relative to the first skirt 2200 by the operation control unit 3000. The second skirt 2400 may include a second skirt body 2420, center ribs 2440, side ribs 2460, first slit holes 2480, and a second pattern part 2490.

The second skirt body 2420 may be a hollow, thin-walled frame. The second skirt body 2420 maintains a state of contact with the first skirt body 2220. The second skirt body 2420 may be connected to the side plates 3700 to be described later via a connecting bracket 3900 to be described later. As a result, the second skirt body 2420 cannot be detached from the first skirt 2200.

The center ribs 2440 may be positioned on a surface of the second skirt body 2420 that is not exposed externally. The center ribs 2440 may be provided in plurality. The side ribs 2460 may be positioned on the outer side of the center ribs 2440 in the width direction. Here, the width direction may be the direction perpendicular to the length direction. The side ribs 2460 may be provided in plurality. The center ribs 2440 and side ribs 2460 may support the second skirt 2400 and enhance its rigidity.

As shown in FIG. 4, The first slit holes 2480 may be formed in the center ribs 2440. The first slit holes 2480 may be positioned along the length direction of the center ribs 2440. The first slit holes 2480 may have an elongated shape. The first slit holes 2480 may accommodate a support protrusion 3443 of the second supporting block 3440 of the support unit 3400 to be described later. The first slit hole 2480 may include a first region 2482 where the support protrusion 3443 of the second support block 3440 makes contact before the second skirt 2400 tilts, and a second region 2484 where the support protrusion 3443 of the second support block 3440 makes contact after the second skirt 2400 tilts.

The second pattern part 2490 may be formed on the exposed surface of the second skirt body 2420. As shown in FIG. 2, the second pattern part 2490 may be formed along the height direction on the exposed surface of the second skirt body 2420. The second pattern part 2490 may include second convex portions and second concave portions that are alternately arranged. In more detail, the exposed surface of the second skirt body 2420 may be patterned with alternating concave and convex regions, where the concave regions form multiple second concave portions, each separated by a second convex portion.

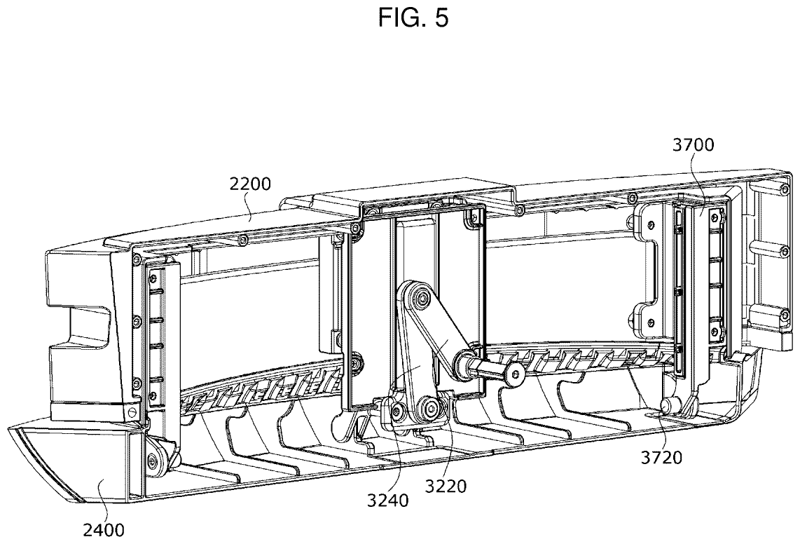

FIG. 5 shows a diagram illustrating the operational control unit coupled to the first skirt and second skirt.

The operation control unit 3000 (e.g., a controller or a processor) may be connected to the first housing 1000 and the skirt unit 2000 to control the operation of the first skirt 2200 and the second skirt 2400. The operation control unit 3000 may include an actuator 3100, a link unit 3200, a slide cover 3300, a support unit 3400, an auxiliary plate 3500, a stopper 3600, side plates 3700, rail blocks 3800, and connecting brackets 3900.

With reference to FIGS. 2 and 5, the actuator 3100 may be coupled to the first-1 housing 1200 of the first housing 1000. The actuator 3100 may be positioned on the outer side of the first-1 housing 1200. The actuator 3100 is connected to an external power supply (not shown) and can generate power. The actuator 3100 may also be connected to the link unit 3200. As a result, the actuator 3100 may rotate the link unit 3200.

The link unit 3200 may be positioned inside the first housing 1000. The link unit 3200 rotates with the power generated by the actuator 3100 and is connected to the support unit 3400, enabling movement of the support unit 3400. The link unit 3200 may include a first link 3220 coupled to the actuator 3100 in a rotatable manner and a second link 3240 coupled to the support unit 3400.

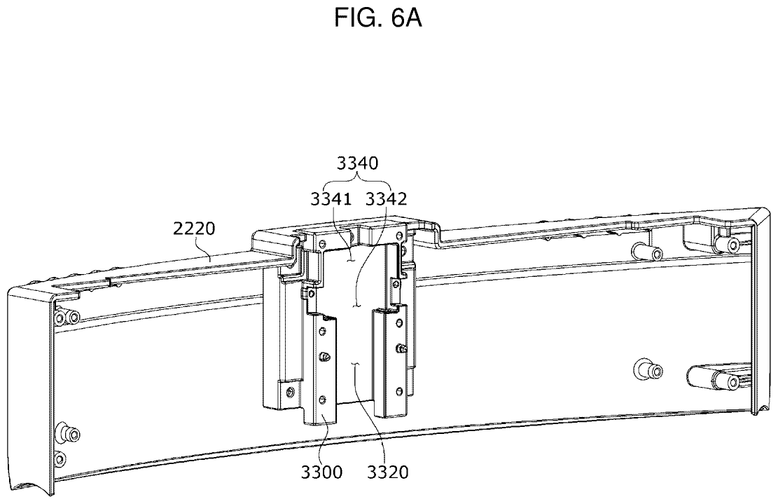

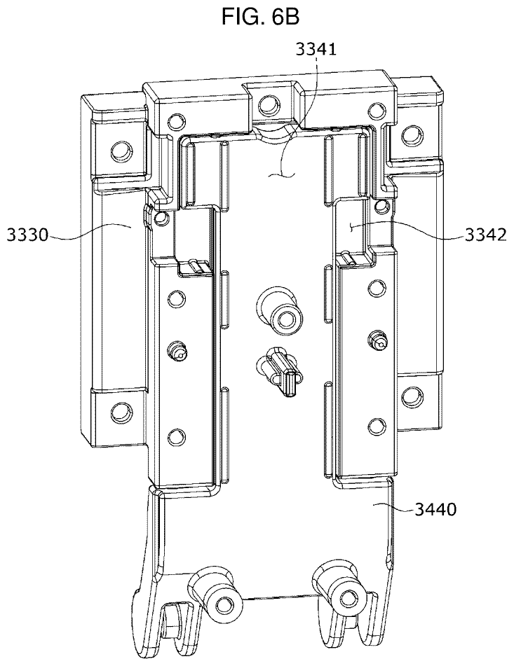

FIG. 6A is a diagram illustrating the slide cover coupled to the first skirt, and FIG. 6B is a diagram illustrating the first support block arranged on the slide cover.

With reference to FIGS. 2, 5, 6A, and 6B, the slide cover 3300 may be positioned inside the first housing 1000. As shown in FIG. 6A, the slide cover 3300 may be fixedly installed on the first skirt 2200. The slide cover 3300 may accommodate a portion of the support unit 3400 in a movable manner. The slide cover 3300 may move together with the first skirt 2200 towards the exterior or interior of the first housing 1000.

As shown in FIG. 6B, the slide cover 3300 may include a second slit hole 3320 and a third slit hole 3340 to accommodate the first movable part 3441 of the later-described second support block 3440 of the support unit 3400. The third slit hole 3340 may be specifically formed to have a length greater than a portion of the first movable part 3441 of the second support block 3440 and may include a third region 3341 maintaining the state where the first movable part 3441 of the second supporting block 3440 is positioned before the first supporting block 3420 moves and a fourth region 3342 where the first supporting block 3420 moves to position the first movable part 3441.

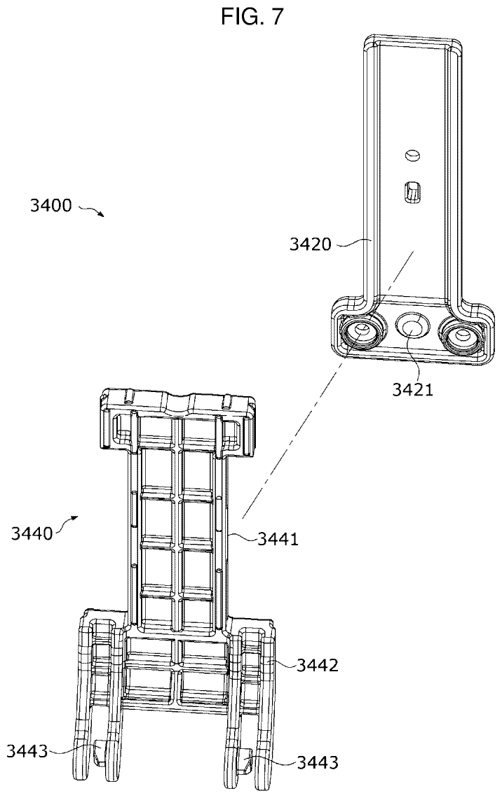

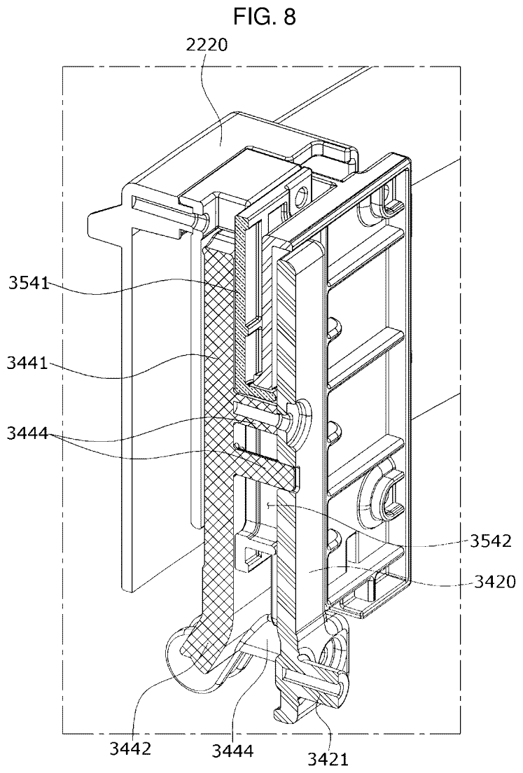

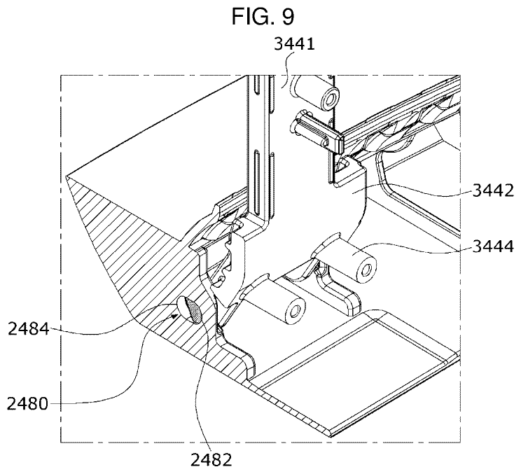

FIG. 7 is an exploded perspective view of the support unit, FIG. 8 is a diagram illustrating cross-section of the first skirt, slide cover, support unit, and auxiliary plate, and FIG. 9 is a diagram illustrating cross-section of the support protrusions of the second support block in the state of being inserted into the first slot hole of the second skirt.

With reference to FIGS. 2, 7, and 9, the support unit 3400 may be positioned inside the first housing 1000. In particular, the support unit 3400 may be positioned between the first-1 and first-2 housings 1200 and 2200 of the first housing 1000. The support unit 3400 may move in the same direction as the movement of the first skirt 2200 and may rotate to support the tilted second skirt 2400 after the extraction of the first skirt 2200 is completed. The support unit 3400 may include the first support block 3420 and the second support block 3440.

As shown in FIGS. 5 and 8, the first support block 3420 may be connected to the link unit 3200. Additionally, the first support block 3420 may be slidably coupled to the later-described first auxiliary plate 3520 of the auxiliary plate 3500.

The first support block 3420 may include a first coupling protrusion 3421. The first coupling protrusion 3421 may be coupled with the second link 3240. As a result, the first support block 3420 may be raised or lowered along the height direction by the first coupling protrusion 3421, which moves along the second link 3240.

The second support block 3440 may be coupled with the first support block 3420. The second support block 3440 may be slidably arranged on the slide cover 3300. The second support block 3440 may include the first movable part 3441, the second movable part 3442, the support protrusions 3443, and second coupling protrusions 3444.

The first movable part 3441 may be positioned inside of the slide cover 3300. The first movable part 3441 may be moved along the height direction together with the slide cover 3300 by the first support block 3420 or may slide independently out of the slide cover 3300.

As shown in FIGS. 5 and 9, the second movable part 3442 may be positioned at the end of the first movable part 3441. The second movable part 3442 may be positioned outside of the slide cover 3300. The second movable part 3442 may move along the height direction together with the first movable part 3441. Additionally, the second movable part 3442 may have a width wider than the first movable part 3441 in the width direction. As a result, during movement along the height direction, the second movable part 3442 may come into contact with the slide cover 3300, limiting further movement of the second support block 3440.

As shown in FIG. 9, the support protrusions 3443 may be positioned on the second movable part 3442. The support protrusions 3443 may be provided in plurality. The plurality of support protrusions 3443 may have a shape that projects towards each other. The support protrusions 3443 may be accommodated in the first slit holes 2480 of the second skirt 2400. The support protrusions 3443 may support the second skirt 2400 in a movable manner. The support protrusions 3443 may support the tilted second skirt 2400 when accommodated in the first slit holes 2480. This prevents further rotation of the second skirt 2400 by the support protrusions 3443, allowing the second skirt 2400 to secure an additional wind blocking area as intended during the manufacturing process. Additionally, supporting the second skirt 2400 with the support protrusions 3443 is capable of preventing excessive rotation of the second skirt 2400, ensuring no gap forms between the first skirt 2200 and the second skirt 2400.

As shown in FIG. 8, the second coupling protrusions 3444 may be formed on the first movable part 3441 and the second movable part 3442. The second coupling protrusions 3444 may protrude from a one side of the first movable part 3441 and the second movable part 3442 that does not face the first skirt 2200 and the second skirt 2400. The second coupling protrusions 3444 may be coupled with the first support block 3420. Due to the second connecting protrusions 3444, the second support block 3440 may move along the height direction in linkage with the movement of the first support block 3420.

In this way, the support unit 3400 is mounted on the slide cover 3300 to allow for slide movement, enabling control of the movement of the second skirt 2400 separately from the first skirt 2200. Consequently, the support unit 3400 eliminates the need for a separate power device to tilt the second skirt 2400, thereby reducing the manufacturing costs of the vehicle air skirt apparatus.

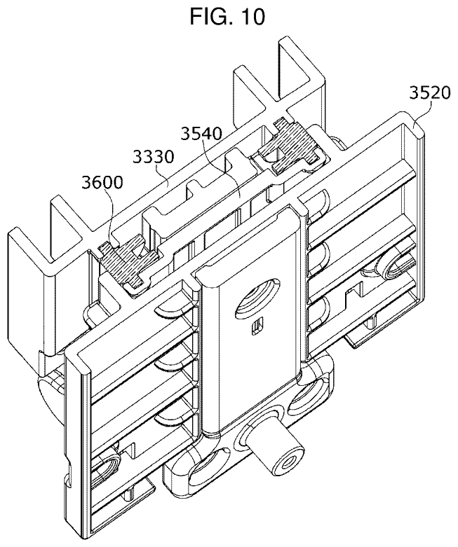

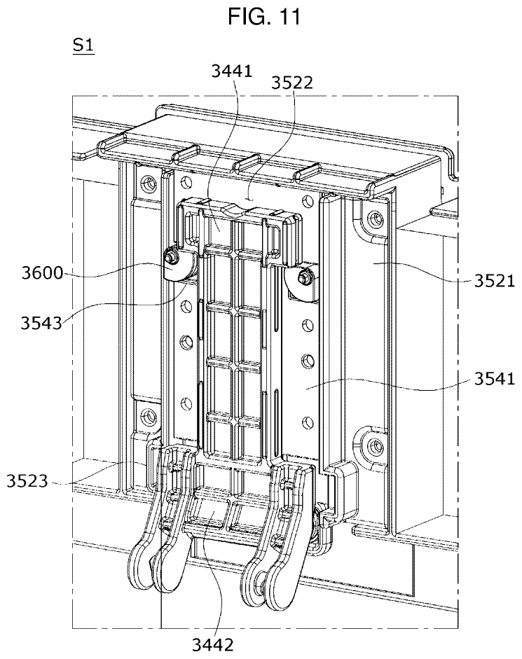

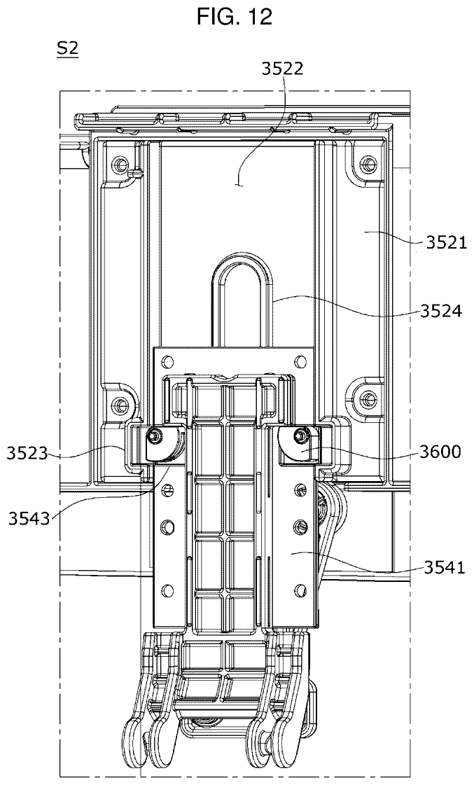

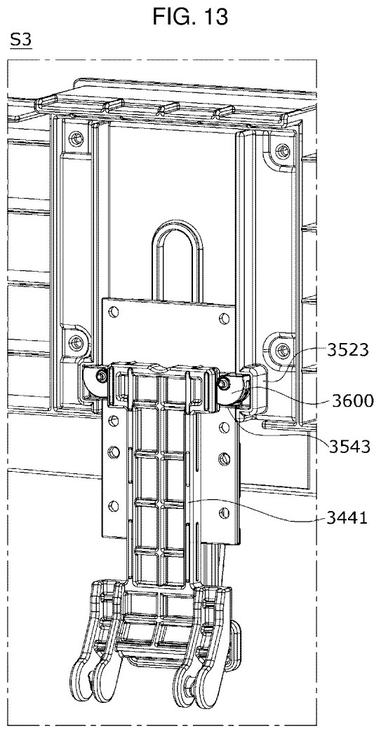

FIG. 10 is a diagram illustrating cross-section of the stopper coupled to the slide cover and second auxiliary plate, FIG. 11 is a diagram illustrating the second support block and stopper in the first state, FIG. 12 is a diagram illustrating the second support block and stopper in the second state, and FIG. 13 is a diagram illustrating the second support block and stopper in the third state.

With reference to FIGS. 2, 5, 8, and 10 to 13, the auxiliary plate 3500 may assist in the movement of the support unit 3400. The auxiliary plate 3500 may include the first auxiliary plate 3520 and the second auxiliary plate 3540.

As shown in FIGS. 8 and 10 to 13, the first auxiliary plate 3520 may include a first plate body 3521, a first receiving groove 3522, a second receiving groove 3523, and a third receiving groove 3524.

The first plate body 3521 may be fixedly mounted to the first-1 housing 1200 of the first housing 1000. The first plate body 3521 may be configured as a combination of a rectangular panel and protrusions extending outward from one side of the panel towards the skirt unit 2000.

The first receiving groove 3522 may be formed on the inner side of the protrusions constituting the first plate body 3521. The first receiving groove 3522 may accommodate the second auxiliary plate 3540 internally. The second receiving groove 3523 may be formed in the end region of the first plate body 3521. The second receiving groove 3523 may be formed in a banded part of a portion of the protrusion constituting the first plate body 3521. The second receiving groove 3523 may be connected to the fourth receiving groove 3543 of the second auxiliary plate 3540 to be described later. The second receiving groove 3523 may rotatably accommodate a portion of the stopper 3600 that has moved downward along the height direction. The third receiving groove 3524 may be formed in the central region of the first receiving groove 3522. As shown in FIGS. 8, 12, and 13, the third receiving groove 3524 may form a movable space for a portion of the second auxiliary plate 3540.

The second auxiliary plate 3540 may be coupled to the first auxiliary plate 3520. The second auxiliary plate 3540 may include a second plate body 3541, a receiving hole 3542, and a fourth receiving groove 3543.

The second plate body 3541 may be slidably arranged in the first receiving groove 3522 of the first auxiliary plate 3520. The second plate body 3541 may be configured as a combination of a rectangular panel and protrusions extending outward from one side of the panel towards the skirt unit 2000.

The receiving hole 3542 may be formed on the inner side of the protrusions constituting the second plate body 3541. As shown in FIG. 8, the receiving hole 3542 may accommodate the second coupling protrusions 3444 of the second support block 3440 of the support unit 3400 in an internally movable manner. As a result, the second support block 3440 of the support unit 3400 may secure additional distance for movement along the height direction.

As shown in FIGS. 11 to 13, the fourth receiving groove may accommodate the stopper 3600 internally in a rotatable manner. The fourth receiving groove 3543 may be positioned on the width-direction end of the second plate body 3541. The fourth receiving groove 3543, when the second plate body 3541 is positioned in the first receiving groove 3522 of the first auxiliary plate 3520, may be closed on one side opened by the protrusions constituting the first plate body 3521. The fourth receiving groove 3543 may be positioned at a location that communicates with the second receiving groove 3523 of the first auxiliary plate 3520 when the second plate body 3541 moves in the height direction. Therefore, the fourth receiving groove 3543 may communicate with the second receiving groove 3523.

As shown in FIGS. 2, 10, and 11 to 13, the stopper 3600 may be rotatably coupled to the slide cover 3300 and may be brought into contact with the first movable part 3441 of the second support block 3440 of the support unit 3400. In more detail, as shown in FIG. 10, the stopper 3600 may be rotatably coupled to both the slide cover 3300 and the second plate body 3541 of the second auxiliary plate 3540. In this state, the stopper 3600 may be rotatable arranged in the fourth receiving groove 3543 of the second auxiliary plate 3540. The stopper 3600 may have a fan-shaped cross-section. When positioned in the fourth receiving groove 3543, the stopper 3600 may maintain a state in which rotation is block by the protrusions constituting the first plate body 3521 of the first auxiliary plate 3520.

As shown in FIGS. 11 to 13, the stopper 3600 may be pressed by the second support block 3440 of the support unit 3400 which moves in linkage with the movement of the link unit 3200 to activate the movement path of the first movable part 3441.

In more detail, as shown in FIGS. 1 and 11, in the first state S1 of the vehicle air skirt apparatus 1 where the first skirt 2200 is not extracted outward from the first housing 1000, the stopper 3600 remains positioned in the fourth receiving groove 3543 of the second auxiliary plate 3540, blocking the rotation by the protrusions constituting the first plate body 3521 of the first auxiliary plate 3520.

In this state, as shown in the transition from FIG. 11 to FIG. 12, when the support unit 3400 is lowered along the height direction by the link unit 3200, particularly when the first movable part 3441 of the second support block 3440 descends in the height direction, the stopper 3600 may be pressed by the first movable part 3441 of the second support block 3440 and thus move downward along with the second auxiliary plate 3540. In this state, the movement path of the first movable part 3441 is still not activated.

In this way, as the stopper 3600 moves together with the second moving part 3442 of the support unit 3400 and the second auxiliary plate 3540, the vehicle air skirt apparatus 1 may transition to the second state S2 where the second skirt 2400 is extracted outward from the first housing 1000. In the second state S2 of the vehicle air skirt apparatus 1, the fourth receiving groove 3543 of the second auxiliary plate 3540 may be positioned to communicate with the second receiving groove 3523 of the first auxiliary plate 3520. Consequently, the stopper 3600 may be allowed to rotate.

In this state, as the support unit 3400 continues to descend along the height direction through the link unit 3200 driven by the power generated from the actuator 3100, the first movable part 3441 of the support unit 3400 maintains continuous pressure on the stopper 3600. Here, since the fourth receiving groove 3543 of the second auxiliary plate 3540 is in the state of communicating with the second receiving groove 3523 of the first auxiliary plate 3520), as in the process from FIG. 12 to FIG. 13, the stopper 3600 may be positioned in the second receiving groove 3523 of the first auxiliary plate 3520 while rotating in place. This may activate the movement path of the first moving part 3441.

In this manner, the stopper 3600 may activate or close the movement path of the second support block 3440 depending on the positions to which the support unit 3400 and the second auxiliary plate 3540 are moved. Therefore, the stopper 3600 may prevent unintended movement (rotation) of the second skirt 2400 during manufacturing by preventing indiscriminate movement of the support unit 3400.

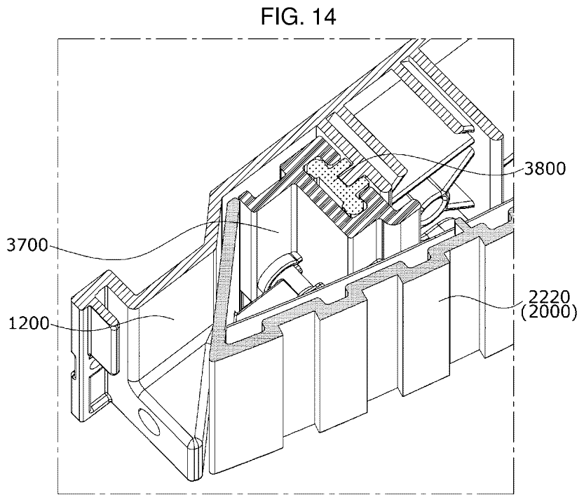

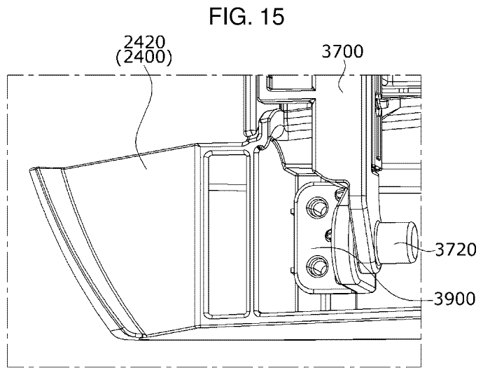

FIG. 14 is a diagram illustrating the arrangement of the side plate and rail block, and FIG. 15 is a diagram illustrating the connecting bracket connecting the second skirt and side plate.

With reference to FIGS. 2, 5, and 14, the side plates 3700 may be fixedly installed on the first skirt 2200. The side plates 3700 may be positioned inside the first skirt 2200 along the height direction. The side plates 3700 may be provided in plurality. The plurality of side plates 3700 may be spaced apart in the width direction. The side plates 3700 may have rail grooves formed internally to accommodate rail blocks 3800.

The side plates 3700 may include a center protrusion 3720. As shown in FIG. 5, the center protrusion 3720 protrudes from the side plate 3700 to rotatably support the second skirt 2400. The center protrusion 3720 serves as the rotational center of the second skirt 2400, allowing the second skirt 2400 to rotate and tilt thereon when moved by the second support block 3440 of the support unit 3400.

With reference to FIGS. 2, 5, and 14, the rail blocks 3800 may be securely installed in the first-1 housing 1200 of the first housing 1000. When coupled to the first-1 housing 1200, the rail blocks 3800 may be positioned within the rail groove formed in the side plate 3700. In this configuration, the rail blocks 3800 may be positioned along the height direction. The rail blocks 3800 may support the side plates 3700 to slide.

With reference to FIGS. 2 and 15, the connecting bracket 3900 may be positioned inside the second skirt 2400. The connecting brackets 3900 may have a ‘7’ shape. The connecting brackets 3900 may connect the second skirt 2400 and the side plates 3700. That is, the second skirt 2400 may be supported by the connecting brackets 3900 attached to the side plates 3700. Since the connecting brackets 3900 are coupled with the second skirt 2400, the second skirt 2400 may rotate around the center protrusions 3720 of the side plates 3700 together with the connecting brackets 3900.

With reference to FIGS. 1 and 2, the lighting module is attached to the first housing to illuminate the first skirt and second skirt moved outward from the first housing. A detailed description of the lighting module will be provided later.

Hereinafter, the operation process of the vehicle air skirt apparatus 1 will be described. For convenience, the description of the operation process of this embodiment is made excluding the lighting module.

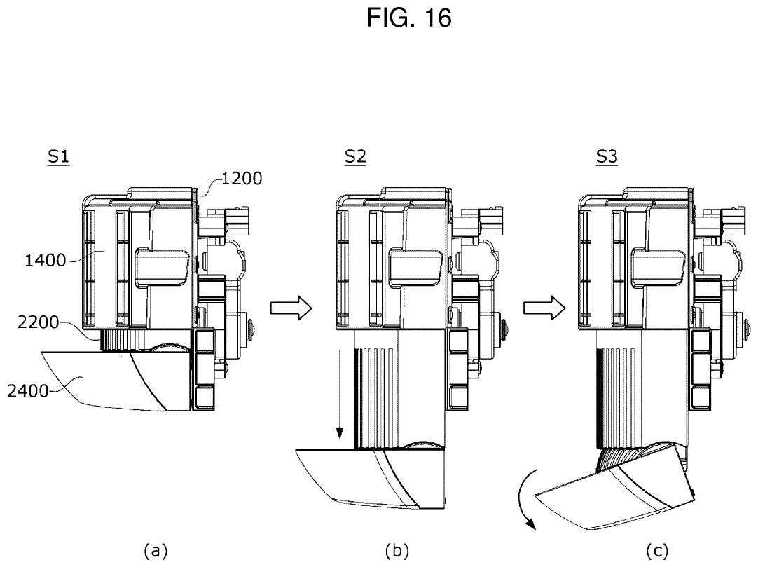

FIG. 16 is a diagram illustrating the air skirt apparatus for a vehicle in the first state, second state, and third state according to an embodiment of the present invention.

With reference to FIGS. 1 to 16, in the first state S1 of the vehicle air skirt apparatus 1 the first skirt 2200 remains retracted and does not extend outside of the first housing 1000 through the extraction hole 1000a of the first housing 1000 as shown in (a) of FIG. 16. In this state, the height-wise end portion of the first skirt 2200 is exposed outside of the first-2 housing 1400. Additionally, in the first state S1, the fourth receiving groove 3543 of the second auxiliary plate 3540 is positioned in a location that is not connected to the second receiving groove 3523 of the first auxiliary plate 3520, as shown in FIG. 11.

In this state, when power is generated from the actuator 3100, the first link 3220 connected to the actuator 3100 rotates, and the second link 3240 connected to the first link 3220 rotates, pressing the first support block 3420 of the support unit 3400 downward in the height direction. As a result, the first support block 3420 descends in the height direction. Here, since the stopper 3600 is prevented from rotating by the first auxiliary plate 3520, the second support block 3440, the second auxiliary plate 3540, and the stopper 3600 descend in the height direction, as shown in the process from FIG. 11 to FIG. 12.

Additionally, since the rail blocks 3800 is fixedly installed on the first-1 housing 1200, the side plates 3700 are guided and moved by the rail blocks 3800. Therefore, the first skirt 2200, which is coupled to the side plates 3700, descends in the height direction along with the side plates 3700, and the slide cover 3300 also descends along with the first skirt 2200. Moreover, the second skirt 2400, which is connected to the side plates 3700 through the connecting brackets 3900, also descends in the height direction along with the side plates 3700 and the connecting brackets 3900. As a result, the vehicle air skirt apparatus 1 transitions from the first state S1 to the second state S2.

In the second state S2 of the vehicle air skirt apparatus 1, the first skirt 2200 and the second skirt 2400 have descended in the height direction compared to the first state S1. In this state, when the actuator 3100 continues to generate power, the link unit 3200 continues to rotate. As a result, the support unit 3400 is pressed downwards along the height direction by the link unit 3200, causing the first moving part 3441 of the second support block 3440 of the support unit 3400 to press the stopper 3600.

At this point, as shown in FIG. 12, since the fourth receiving groove 3543 of the second auxiliary plate 3540 is positioned in communication with the second receiving groove 3523 of the first auxiliary plate 3520, when the first moving part 3441 of the second support block 3440 presses the stopper 3600, the stopper 3600 may rotate in place and move toward the second receiving groove 3523 of the first auxiliary plate 3520, ultimately being positioned in the second receiving groove 3523. As a result, as shown in FIG. 13, the movement path of the first moving part 3441 of the second support block 3440 may be activated.

In the state where the movement path of the first moving part 3441 is activated, as the support unit 3400 is being lowered by the link unit 3200, the first moving part 3441 of the second support block 3440 may move from the third region 3341 to the fourth region 3342 of the third slit hole 3340 of the slide cover 3300, as shown in FIG. 6bB. Consequently, further movement of the second support block 3440 is blocked.

In this process of blocking the movement of the second support block 3440 is blocked, the second movable part 3442 of the second support block 3440 further lowers the second skirt 2400 compared to the second state S2. Since the connecting brackets 3900 are rotatably connected to the side plates 3700, the second skirt 2400 attached to the connecting brackets 3900 rotates together with the connecting brackets 3900 around the center protrusions 3720 of the side plates 3700. Therefore, the second skirt 2400 tilts from the second state S2, and the vehicle air skirt apparatus 1 transitions to the third state S3.

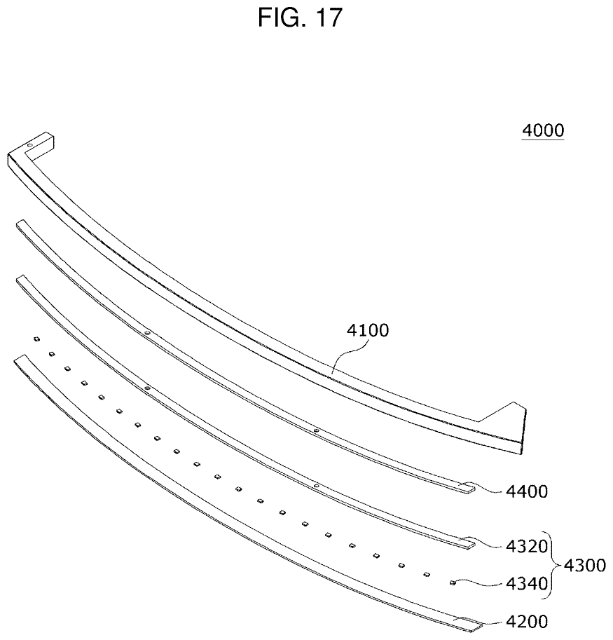

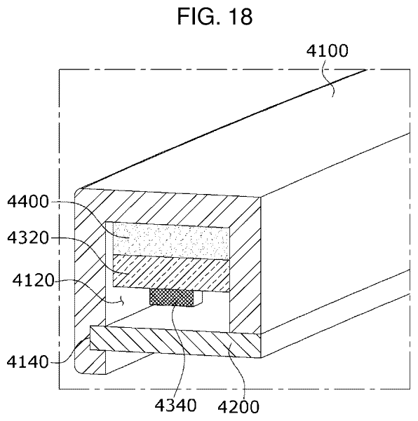

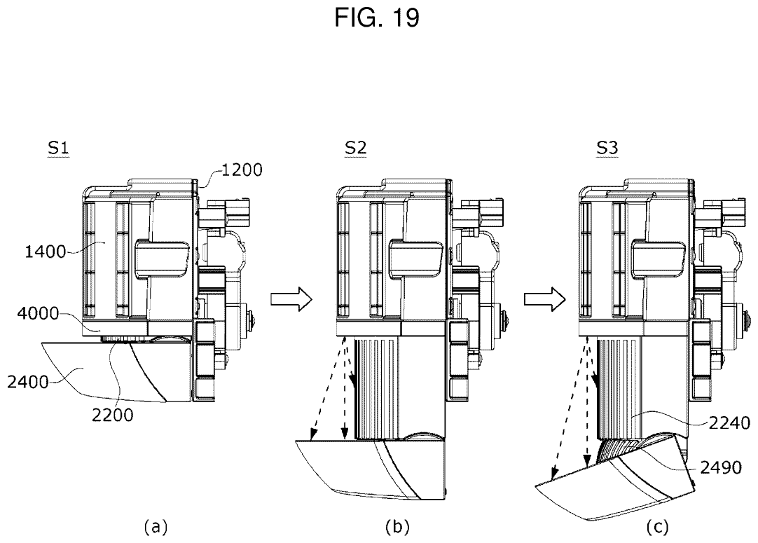

FIG. 17 is an exploded perspective view of the lighting module, FIG. 18 is a diagram illustrating cross-section of the lighting module, and FIG. 19 is a diagram illustrating the light source of the lighting module illuminating the first skirt and second skirt in the second state and third state according to an embodiment of the present invention.

With reference to FIGS. 1, 2, 17, and 18, the lighting module 4000 may include a second housing 4100, a lens 4200, a light source unit 4300, and an adhesive material 4400.

The second housing 4100 may be coupled to the first-1 housing 1200 of the first housing 1000. In more detail, the second housing 4100 may be positioned below the first-1 housing 1200 of the first housing 1000 along the height direction. The second housing 4100 may enclose a portion of the first skirt body 2220 of the first skirt 2200 while being coupled to the first-1 housing 1200. The second housing 4100 may slidably accommodate the first skirt body 2220. The second housing 4100 may have a hollow shape. That is, as shown in FIG. 18, the second housing 4100 may be formed with a first placement groove 4120 for accommodating the light source unit 4300. In addition, the second housing 4100 may be formed with a second placement groove 4140 where a portion of the lens 4200 may be inserted and supported.

The lens 4200 may be positioned within the second housing 4100. In more detail, a portion of the lens 4200 may be inserted into the second placement groove 4140 of the second housing 4100. This allows the lens 4200 to be supported by the second housing 4100. The lens 4200 may be made of a material capable of transmitting light generated by the light source unit 4300. The lens 4200 may be positioned facing the second skirt 2400 in its pre-tilted state.

The light source unit 4300 may be positioned between the second housing 4100 and the lens 4200 to project light towards the lens 4200. In more detail, the light source unit 4300 may be placed inside the first placement groove 4120 formed within the second housing 4100. The light source unit 4300 may include a substrate 4320 that receives an external control signals and supplies power to a light source 4340 via the received control signals, and the light source 4340 that generates light by receiving power through the substrate 4320. Here, the substrate 4320 may be a printed circuit board (PCB). The light source 4340 may be provided in plurality, and the plurality of light sources 4340 may be arranged apart inside the first placement groove 4120 of the second housing 4100.

The adhesive material 4400 may be positioned inside the first placement groove 4120 of the second housing 4100. While positioned inside the first placement groove 4120, the adhesive material 4400 may adhere to the inner surface of the second housing 4100 forming the first placement groove 4120. Furthermore, the adhesive material 4400, when adhered to the inner surface of the second housing 4100, may support the substrate 4320 of the light source unit 4300. Such adhesive material 4400 may include double-sided tape, Velcro, or an adhesive with flowing properties.

Although not shown in the drawing, the lighting module 4000 may include wiring. The wiring may be connected to the substrate 4320 of the light source unit 4300 located in the first placement groove 4120 of the second housing 4100 and to an external control unit (not specified). Therefore, the wiring may transmit control signals from the control unit to the substrate 4320 of the light source unit 4300.

With reference to FIG. 19, the lighting module 4000 may illuminate the first skirt 2200 and the second skirt 2400 in the second state S2 and the third state S3.

As shown in (b) of FIG. 19, in the second state S2, the light generated by the lighting module 4000 may illuminate the first pattern part 2240 of the first skirt 2200 and the area of the exposed surface of the second skirt 2400 where the second pattern part 2490 is not formed. Additionally, as shown in (c) of FIG. 19, in the third state S3, the light generated by the lighting module 4000 may illuminate the first pattern part 2240 of the first skirt 2200, the second pattern part 2490 of the second skirt 2400, and the area of the exposed surface of the second skirt 2400 where the second pattern part 2490 is not formed.

In this way, according to an embodiment of the present invention, the vehicle air skirt apparatus 1 can add to the aesthetic appeal of the front appearance of the vehicle by illuminating the first skirt 2200 and the second skirt 2400 with light from the lighting module 400 in the second state S2 and third state S3. This improves the vehicle's design aesthetics, potentially boosting marketability.

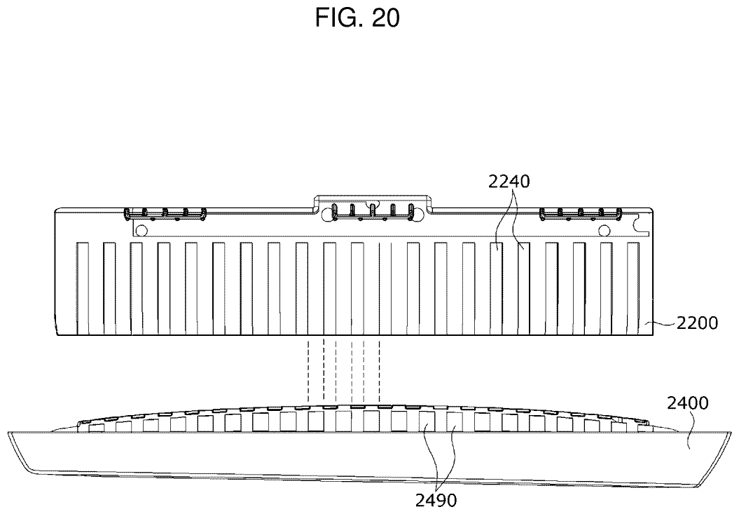

FIG. 20 is a diagram illustrating the first skirt and second skirt separated apart from each other.

With reference to FIG. 20, the second pattern part 2490 of the second skirt 2400 may be aligned on the same line as the first pattern part 2240 of the first skirt 2200. In more detail, as shown in FIG. 20, the first concave portion of the first pattern part 2240 of the first skirt 2200 and the second concave portion of the second pattern part 2490 of the second skirt 2400 may be aligned on the same line, and the first convex portion of the first pattern part 2240 of the first skirt 2200 and the second convex portion of the second pattern part 2490 of the second skirt 2400 may also be aligned on the same line. This alignment of the first pattern part 2240 and second pattern part 2490, when illuminated by the lighting module 4000 after the tilting of the second skirt 2400, may give the viewer looking at the first skirt 2200 and the second skirt 2400 an impression of design stability.

According to an embodiment of the present invention, light generated from a lighting unit illuminates the deployed first and second skirts, thereby enhancing the front-end design aesthetics of the vehicle when the first and second skirts are deployed.

While the foregoing description has focused on specific embodiments of the present invention, it should be understood that various modifications and changes can be made by those skilled in the art without departing from the spirit and scope of the invention as defined in the appended claims. Furthermore, any distinctions arising from such modifications and changes should be understood to fall within the scope of the present invention as delineated in the appended claims.

### DESCRIPTION OF REFERENCE NUMERALS

| | |
|---|---|
| 1: vehicle air skirt apparatus | 1000: first housing |
| 1000a: extraction hole | 1200: first-1 housing |
| 1400: first-2 housing | 2000: skirt unit |
| 2200: first skirt | 2220: first skirt body |
| 2240: first pattern part | 2400: second skirt |
| 2420: second skirt body | 2440: center rib |
| 2460: side rib | 2480: first slit hole |
| 2482: first region | 2484: second region |
| 2490: second pattern part | |
| 3000: operation control unit | |
| 3100: actuator | 3200: link unit |
| 3220: first link | 3240: second link |
| 3300: slide cover | 3320: second slit hole |
| 3340: third slit hole | 3341: third region |
| 3342: fourth region | 3400: support unit |
| 3420: first support block | |
| 3421: first coupling protrusion | |
| 3440: second support block | 3441: first movable part |
| 3442: second movable part | 3443: support protrusion |
| 3444: second coupling protrusion | 3500: auxiliary plate |
| 3520: first auxiliary plate | 3521: first plate body |
| 3522: first receiving groove | |
| 3523: second receiving groove | |
| 3524: third receiving groove | |
| 3540: second auxiliary plate | |
| 3541: second plate body | 3542: receiving hole |
| 3543: fourth receiving groove | 3600: stopper |
| 3700: sidle plate | 3720: center protrusion |
| 3800: rail block | 3900: connecting bracket |
| 4000: lighting module | 4100: second housing |
| 4120: first placement groove | |
| 4140: second placement groove | |
| 4200: lens | 4300: light source unit |
| 4320: substrate | 4340: light source |
| 4400: adhesive material | S1: first state |
| S2: second state | S3: third state |

What is claimed is:

1. An air skirt apparatus for a vehicle, the apparatus comprising:
a first housing comprising an extraction hole;
a skirt unit comprising:
a first skirt movably disposed inside the first housing and configured to protrude outside the first housing through the extraction hole; and
a second skirt configured to tilt by rotating after a complete extraction of the first skirt;
a support unit configured to move in the same direction as the first skirt and rotatably support the second skirt tilting after the complete extraction of the first skirt; and
a lighting module coupled to the first housing and configured to illuminate the first skirt and the second skirt in response to the first skirt being moved outward from the first housing.

2. The apparatus of claim 1, wherein the lighting module comprises:
a second housing coupled to the first housing;
a lens disposed in the second housing and configured to face the second skirt before tilting; and
a light source unit disposed between the second housing and the lens and configured to illuminate light toward the lens.

3. The apparatus of claim 2, wherein the first skirt comprises:
a first skirt body disposed movably inside the first housing; and
a first pattern part formed on an exposed surface of the first skirt body and comprising first convex portions and first concave portions arranged alternately.

4. The apparatus of claim 3, wherein the second skirt comprises:
a second skirt body arranged to be tiltable in relation to the first skirt body of the first skirt; and
a second pattern part formed on an exposed surface of the second skirt body and comprising second convex portions and second concave portions arranged alternately, the second pattern part being arranged on a same line as the first pattern part of the first skirt.

5. The apparatus of claim 4, wherein the second pattern part of the second skirt is exposed externally after the tilting of the second skirt body.

6. The apparatus of claim 1, further comprising:
a slide cover fixedly installed on the first skirt,
wherein the support unit is slidably arranged on the slide cover.

7. The apparatus of claim 6, further comprising a link unit connected to the support unit to move the support unit,
wherein the support unit comprises:
a first support block connected to the link unit; and
a second support block coupled with the first support block and movably disposed on the slide cover.

8. The apparatus of claim 7, wherein the second support block of the support unit comprises:
a first movable part positioned inside of the slide cover;
a second movable part positioned at one end of the second movable part outside of the slide cover; and
a support protrusion positioned on the second movable part and configured to movably support the second skirt.

9. The apparatus of claim 8, further comprising:
a stopper rotatably coupled to the slide cover and contacting the first movable part of the second support block of the support unit.

10. The apparatus of claim 9,
wherein the stopper is pressed by the second support block of the support unit, and
wherein the second support block moves in linkage with the movement of the link unit, to activate the movement path of the first movable part.

11. An air skirt system for a vehicle, the air skirt system comprising:
a housing;
a first air skirt;
a second air skirt attached to the first air skirt;
an actuator;
a controller configured to control the actuator to move the first air skirt to at least one of:
a retracted position in which the first air skirt is retracted in the housing;
an extended position in which the first air skirt is extended out of the housing;
a tilted position in which the second air skirt is rotated in relation to the first air skirt; or
any combination thereof; and
one or more light modules coupled to at least one of the housing, the first skirt, the second skirt, or any combination thereof,
wherein the controller is further configured to control the one or more light modules to illuminate at least one of the housing, the first skirt, the second skirt, or a combination thereof, in at least one of the retracted position, the extended position, or the tilted position.

12. The air skirt system of claim 11, wherein the housing includes an extraction hole through which the first skirt protrudes out of or retracts into the housing.

13. The air skirt system of claim 11, wherein the controller is further configured to control the second skirt to tilt after the first skirt is moved into the extended position.

14. The air skirt system of claim 11, further comprising:
a support attached to the first skirt and configured to:
support the second skirt; and
enable the second skirt to rotate in the tilted position.

15. The apparatus of claim 11, wherein the one or more lighting modules includes:
a lens configured to face at least one of the housing, the first skirt, the second skirt, or any combination thereof; and
a light source configured to illuminate light toward the lens.

16. The apparatus of claim 11, wherein the first skirt comprises:
a first skirt body disposed movably inside the housing; and
a first pattern part formed on an exposed surface of the first skirt body, the first pattern part including first convex portions and first concave portions arranged alternately.

17. The apparatus of claim 16,
wherein the second skirt comprises:
a second skirt body configured to be tiltable in relation to the first skirt body of the first skirt; and
a second pattern part formed on an exposed surface of the second skirt body and including second convex portions and second concave portions arranged alternately, and
wherein the second pattern part is arranged on a same line as the first pattern part of the first skirt.

18. The apparatus of claim 17, wherein the second pattern part of the second skirt is configured to be exposed externally after the second skirt body is tilted.

19. The apparatus of claim 11, further comprising:
a slide cover fixedly installed on the first skirt,
wherein the support is slidably arranged on the slide cover.
